(19) United States
(12) Patent Application Publication
(10) Pub. No.: US 2005/0000062 A1
(43) Pub. Date: Jan. 6, 2005

(54) Clamping device for glass containers with flanged connections

(76) Inventor: Peter Lin, Warminster, PA (US)

Correspondence Address: Eric A. LaMorte;LaMorte & Associates, P.C., P.O. Box 434, Yardley, PA, 19067, US

(21) Appl. No.: 10/611,156

(22) Filed: Jul. 2, 2003

(51) Int. Cl. F16L 33/00

(52) U.S. Cl. 24/279

(57) ABSTRACT

A clamping device for joining two flanged connections. The clamping device has a plurality of arcuate segments, wherein each of the arcuate segments defines a groove. The material of the arcuate segments surrounding the groove is a plastic compound, such as polytetrafluoroethylene. Accordingly, the material around the groove yields when overly compressed. The clamp is designed to provide a controlled clamping force, wherein the clamping device is strong enough to compress an O-ring between flanged connections but is soft enough not to damage flanged connections made of brittle material, such as glass.

### BACKGROUND OF THE INVENTION

1. Field of the Invention

The present invention relates to clamping devices, commonly known as pipe clamps, that are used to join together the flanged ends of two objects so that a fluid impervious seal is created between'the opposing flanges. More particularly, the present invention relates to such clamping devices that are used to join fragile flanged connections, such as those made of glass.

2. Description of the Prior Art

In the manufacture and processing of pharmaceutical products, dairy products and other materials that require a sanitary processing environment, it is common for materials to be pumped from between points using a network of fixed pipes. To introduce materials into the processing system, supply trucks or supply containers are coupled to one of the pipes in the system. In many instances, the connections between supply containers and pipes are made by aligning and joining flanged connections. Flanged connections are also a very common method of interconnecting different segments of pipe within the system. A flanged connection is a termination that can be constructed at the end of a pipe or at a port of a container. The flanged connection is a circular flange that radially extends from a pipe or the neck of a container, wherein the flange extends outwardly in the same plane as the open end of the pipe or container. To join any two flanged connections together, the two flanges are placed in abutment so that the openings in the center of each of the flanges align. An O-ring or other seal is placed between the two flanges. The flanges are then clamped together in a manner that compresses the O-ring and prevents the flanges from falling out of alignment.

In the prior art, there are many different types of clamping devices that have been used to join together flanged connections. Typically, the clamping devices are annular in shape. Hinges are disposed along the annular structure to enable the annular structure to open. The clamping devices typically contain a rocking bolt that is pivotably connected to one end of the clamp. A wing nut is positioned on the rocking bolt. The wing nut passes over a slot that is positioned on the opposite end of the clamp. By tightening the wing nut, the diameter of the clamping device can be reduced and the clamping device can be tightened over the flanged connections. As the diameter of the clamping device decreases, the clamping device biases the adjoining flanges together and prevents the adjoining flanges from moving out of alignment.

Since clamping devices are commonly used to join metal pipes or seal metal containers, prior art clamping devices are traditionally also made of metal, such as steel or stainless steel. As such, the clamping devices are very strong. However, pipe clamp clamping devices are not only used to join together pipes. In the pharmaceutical industry, many small containers have openings that are terminated with flanged connections. Flanged connections are used because other closure styles, such as threaded closures, can harbor contaminants.

Traditionally, metal pipe clamps have been used to cap such small containers or join such small containers to other piping. The clamping force created by traditional metal pipes often far exceeds what is needed to properly seal a small container. Furthermore, many containers are made of glass and have glass flanged connections. When a cap is clamped to such a glass container, the clamping forces exerted by the clamp can cause the glass flange to fracture or otherwise break. The resulting broken glass can contaminate the contents of the container, thereby rendering the contents of the container unusable.

A similar problem occurs when glass cap elements are used. Often a metal container is capped with a glass cap so that the contents of the metal container can be observed. When the glass cap is clamped into place, the forces exerted by a metal clamp can also cause the glass cap to fracture.

A need therefore exists in the art for a clamping device for flanged connections that can be used to clamp a glass flange and/or a glass cap with enough clamping force to create a good seal but not enough force to break the glass material being clamped. This need is met by the present invention as described and claimed below.

### SUMMARY OF THE INVENTION

The present invention is a clamping device for joining two flanged connections. The clamping device has a plurality of arcuate segments, wherein each of the arcuate segments defines a groove. The material of the arcuate segments surrounding the groove is a plastic compound, such as polytetrafluoroethylene. Accordingly, the material around the groove yields when overly compressed. The clamp is designed to provide a controlled clamping force, wherein the clamping device is strong enough to compress an O-ring between flanged connections but is soft enough not to damage flanged connections made of brittle material, such as glass.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is an exploded perspective view of an embodiment of a clamping device shown in conjunction with a glass vessel, a glass cap and an O-ring;

FIG. 2 is an exploded view of the clamping device shown in FIG. 1;

FIG. 3 is a cross-sectional view of the clamping device of FIG. 1 shown clamping a cap to a vessel; and

FIG. 4 is a graph showing O-ring compression as a function of compression force exerted by the clamping device;

FIG. 5 shows an alternate embodiment of the present invention clamping device.

### DETAILED DESCRIPTION OF THE INVENTION

Although the present invention clamping device can be used to clamp together any two flanged connections, the present invention clamping device is particularly useful in clamping together flanged connections with a force that does not exceed a predetermined maximum. Accordingly, the present invention clamping device is particularly well suited for clamping together flanged connections where one or both of the flanged connections is made of glass or some other brittle material. The embodiments of the present invention that are illustrated show the present invention clamping device used to clamp glass components in order to present the best mode contemplated for the invention.

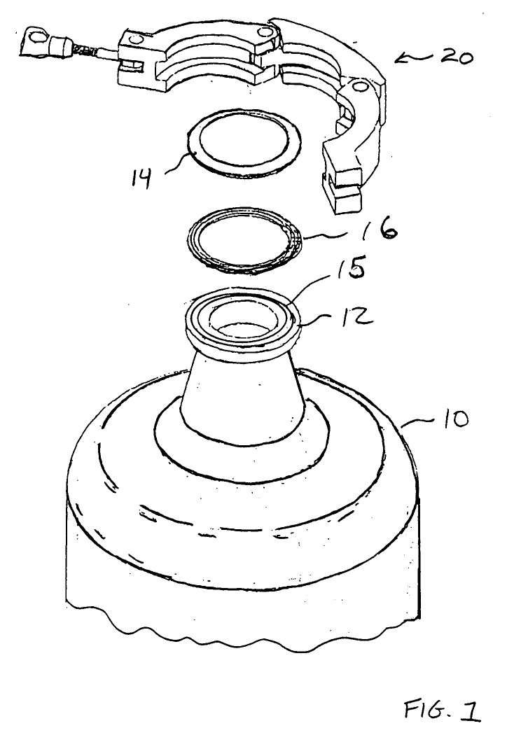

Referring to FIG. 1, there is shown a glass container 10 with a flanged connection 12. The container 10 is to be sealed with a glass cap 14. The flanged connection 12 on the container 10 and the glass cap 14 have the same diameter and peripheral shape. Both the glass cap 14 and the flanged connection 12 have a flat sealing surface. A groove 15 is formed in the flat sealing surfaces of both the flanged connection 12 and the glass cap 14 to receive and retain an O-ring 16. The O-ring 16 is disposed between the opposing sealing surfaces and creates the desired seal when compressed.

The present invention is, a clamping device 20 that can be used to bias the glass cap 14 against the flanged connection 12 to compress the O-ring 16. However, the force applied by the clamping device 20 is controlled and is calculated not to exceed the maximum stress load of either the glass cap 14 or the flanged connection 12.

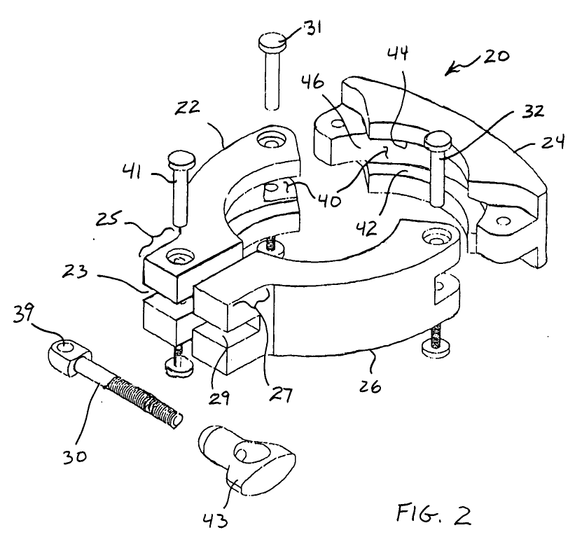

Referring to FIG. 2, a first exemplary embodiment of a clamping device 20 is shown in accordance with the present invention. From FIG. 2, it can be seen that the clamping device 20 contains a plurality of arcuate segments 22, 24, 26. The arcuate segments 22, 24, 26 are joined together, thereby forming a structure that can be configured into a generally annular shape. The first arcuate segment 222 terminates with a leg section 25 that radially extends away from the center of radius for that arcuate segment 22. A slot 23 is formed in the center of the leg section 25, as is common in prior art designs. The last arcuate segment 26 also contains a leg section 27 that defines a slot 29.

In the embodiment of FIG. 2, the first arcuate segment 22 is connected to the middle arcuate segment 24 at a pivot pin 31. Similarly, the last arcuate segment 26 is also connected to the middle arcuate segment 24 with a pivot pin 32. This enables the first arcuate segment 22, the middle arcuate segment 24 and the last arcuate segment 26 to move relative one another between an open condition and a closed condition.

A rocking bolt 30 is provided. The rocking bolt 30 has a base 37 with a hole 39 in it that passes into the slot 23 on the leg 25 of the first arcuate segment 22. The base 37 of the rocking bolt 30 is connected to the leg section 25 within the slot 23 by a pivot 41. The pivot pin 41 enables the rocking bolt 30 to rotate freely within the range of the slot 23.

The rocking bolt 30 is threaded and a butterfly nut 43 engages the threading on the rocking bolt 30. As will later be explained, by tightening and loosening the butterfly nut 43, the clamping device 20 can be selectively tightened and loosened, respectively.

The first arcuate segment 22, middle arcuate segment 24 and last arcuate segment 26 all define arcuate central grooves that combine for form a circular groove 40, when the clamping device 10 is fully closed. The circular groove 40, at all points, are defined by a sloping base surface 42, a sloping top surface 44 and a vertical rear wall 46.

The first arcuate segment 22, middle arcuate segment 24 and last arcuate segment 26 are all made of a plastic composition. However, only specific plastic compositions can be used. The selected plastic composition must have high strength and a high resistance to elastic creep over time. In this manner, when the clamping device 20 is tightly clamped, the integrity of the clamping force will remain generally constant over time. If the plastic selected is too soft, the clamping force applied by the claming device 20 would dissipate as the plastic creeps over time.

The plastic composition selected must also be highly heat resistant. When used in a pharmaceutical setting, the clamping device 20 is periodically sanitized in an autoclave. Heat in an autoclave surpasses the boiling point of water and relies on super heated steam to sanitize equipment. Clamping devices may pass through hundreds of autoclave cycles during their functional lives. Few plastic compositions are capable of being repeatedly autoclaved at such temperatures without deteriorating.

Another required criterion of the plastic composition selected is that it must have a low porosity and nearly negligible absorption characteristics. The clamping device 10 may be exposed to many chemical agents, including bioreactive agents. Accordingly, the plastic composition should not be able to absorb any such agent and harbor that agent during an autoclave procedure.

The last required criterion for the selected plastic composition is that it be highly resistant to solvents. The clamping device 20 may be exposed to many different chemical compounds, including a variety of solvents and petroleum distillates. Many plastics dissolve in a variety of petroleum distillates. Accordingly, such plastics cannot be used.

Although several polymers meet the above criteria, the preferred material for the manufacture of the arcuate segments 22, 24, 26 is polytetrafluoroethylene, which is commonly known as (PTFE). PTFE has good strength, good resistance to plastic creep, high temperature resistance and is inert to most all chemical reagents.

The pivot pins 31, 32 that interconnect the first arcuate segment 22, the middle arcuate segment 24 and the last arcuate segment 26 can be traditional stainless steel pivot pins. Similarly, the rocking bolt 30, rocking bolt pivot pin 41 and the butterfly nut 43 can also be made of metal.

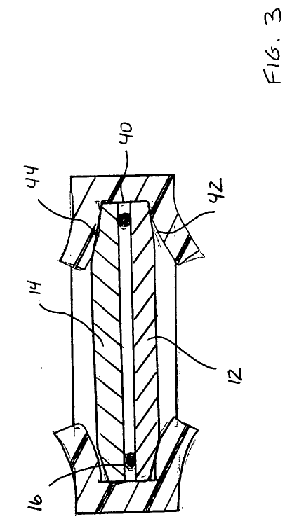

Referring to FIG. 3, it can be seen that as the claming device 20 is placed around the glass cap 14 and the flanged connection 12, the top surface of the glass cap 14 and the bottom surface of the flanged connection 12 come into contact with the sloped top surface 44 and the sloped bottom surface 42 of the groove 40 in the clamping device 20. As the clamping device 20 is tightened, the diameter of the groove 40 becomes smaller and the glass cap 14 and the flanged connection 12 are compressed together. As the glass cap 14 and the flanged connection 12 are compressed together, the O-ring 16 compresses and the glass cap 14 and the flanged connection 12 move toward each other with relative little clamping force. However, when the O-ring 16 nears full compression, the compression force needed to further compress the O-ring 16 increases exponentially. As can be seen from FIG. 3, the structure of the clamping device 20 above the sloped top surface 44 of the groove 40 and below the sloped bottom surface 42 of the groove 40 can deform slightly due to its plastic composition. This yielding of the structure of the clamping device 20 prevents the clamping device 20 from exerting enough compression force to cause either the glass cap 14 or the glass flanged connection 12 to break.

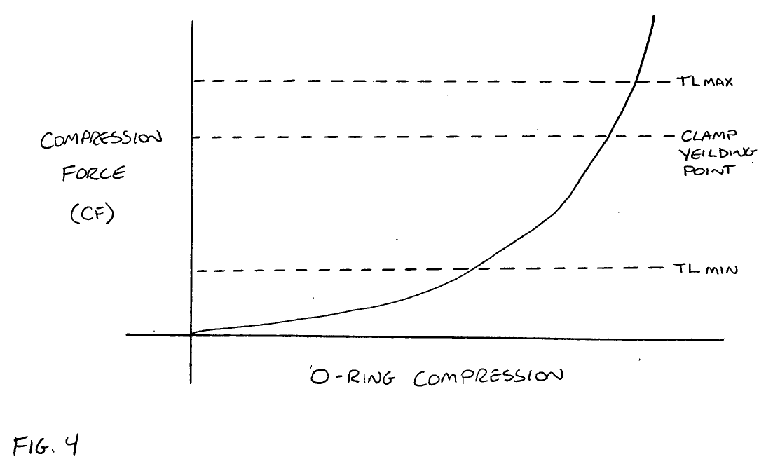

Referring to FIG. 4, it can be seen that as the clamping device 20 (FIG. 3) is tightened and the compression forces increase, the O-ring 16 (FIG. 3) compresses. However, as the O-ring 16 compresses, the force needed to further compress the O-ring 16 increases exponentially. Eventually, the compression force needed to compress the O-ring surpasses the structural capacity of the glass cap 14 (FIG. 3) or the glass flanged connection (FIG. 3). As such, if the compression force exceeds this maximum threshold level TLₘₐₓ, the glass cap or flanged connection will break.

Fortunately, the minimum threshold level TLₘᵢₙ, of the compression force needed to create a seal with the O-ring, is much smaller than the maximum threshold level TLₘₐₓ that damages the glass components. The clamping device 20 is designed so that the plastic above the groove 40 and the plastic below the groove 40 begins to yield at a compression force (cf) between the minimum threshold level TLₘᵢₙ and the maximum threshold level TLₘₐₓ. The deflection of the plastic is shown in FIG. 3. Due to the yield of the plastic material, the compression forces level off as the plastic yields. Accordingly, the clamping device 20 (FIG. 3) reaches its fully clamped condition prior to the compression forces ever reaching the maximum threshold level TLₘₐₓ. The clamping device 20 (FIG. 3) can therefore be over tightened and will not cause damage to any glass cap or glass flanged connection.

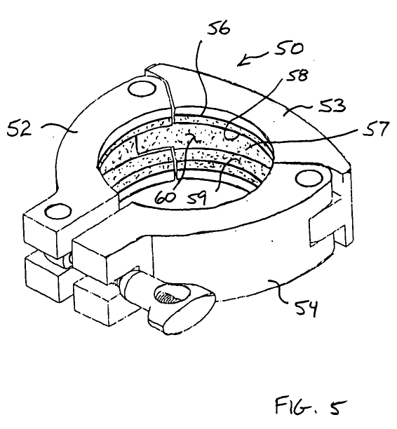

Referring now to FIG. 5, an alternate embodiment of the present invention clamping device 50 is shown. In this embodiment, the arcuate segments 52, 53, 54 of the clamping device 50 are made of metal, rather than plastic. Machined into the interior of the metal arcuate segments 52, 53, 54 is an oversized relief. An insert 56 is placed within the oversized relief. The insert 56 is made of a plastic compound such as PTFE. On the interior of the insert 56 is formed a groove 60. It is the groove 60 that contacts the components that are to be clamped together. The groove 60 has a sloped top surface 58, a sloped bottom surface 59 and a vertical rear wall 57.

Since the plastic insert 56 is supported by metal arcuate segments 52, 53, 54, the plastic does not yield as much as a totally plastic clamp would. However, the plastic does yield far more than metal when stressed. The yield of the plastic insert 56 prevents the clamping device 50 from providing a clamping force that is above the maximum threshold level TLₘₐₓ, previously illustrated in FIG. 4.

It will be understood that the various figures described above illustrate only two preferred embodiment of the present invention. A person skilled in the art can make numerous alterations and modifications to the shown embodiments utilizing functionally equivalent components to those shown and described. For example, the clamping device can contain any number of arcuate segments and is not limited to three. All such modifications are intended to be included within the scope of the present invention as defined by the appended claims.

1. A clamping device for a flanged connection, comprising:
a plurality of arcuate segments containing a first arcuate segment and a last arcuate segment, each of said plurality of arcuate segments containing a plastic section that is comprised, at least in part, of a plastic compound;
at least one pivot pin that joins together said plurality of arcuate segments and enables said plurality of arcuate segments to be manipulated between an open condition and a closed condition;
wherein said plurality of arcuate segments form an annular structure when in said closed condition, said annular structure defining an internal annular groove, wherein said annular grove extends through said plastic section of each of said plurality of arcuate segments; and
a rocking bolt for locking said plurality of arcuate segments in said closed condition.

2. The device according to claim 1, wherein said plastic compound includes polytetrafluoroethylene.

3. The device according to claim 1, wherein each of said plurality of arcuate segments are completely fabricated of polytetrafluoroethylene.

4 The device according to claim 1, wherein each of said plurality of arcuate segments contains a section made of metal that supports said plastic section.

5. The device according to claim 1, wherein each plastic section yields when compressed with a predetermined threshold pressure.

6. A clamping device comprising:
a plurality of arcuate segments joined together by at least one pivot pin, wherein each of said arcuate segments are made of polytetrafluoroethylene;
a rocking bolt for locking said arcuate segments into an annular configuration.

7. The device according to claim 6, wherein a groove is formed in each of said plurality of arcuate segments, each said groove being defined by a top surface and a bottom surface, wherein said top surface and said bottom surface deform when said clamping device is clamped to a predetermined clamping force.

8. A method of creating a seal between two flanged connections that can break if subjected to a predetermined maximum compression force, said method comprising the steps of:
placing an O-ring between the two flanged connections, wherein the O-ring requires a minimum compression force to create a seal that is, less than said predetermined maximum compression force;
providing a clamping device capable of providing a maximum clamping compression force greater, than said minimum compression force and less than said predetermined maximum compression force;
placing said clamping device around said two flanged connections;
tightening said clamping device to said maximum clamping compression force, thereby compressing said O-ring without damaging said flanged connections.

9. The method according to claim 8, wherein said clamping device includes a plurality of arcuate segments that are made of polytetrafluoroethylene.

10. The method according to claim 9, wherein said arcuate, segments define a groove having a top surface and a bottom surface, wherein said top surface and sad bottom surface yield when said clamping device is at its maximum claming compression force.
